(19) United States
(12) Patent Application Publication
(10) Pub. No.: US 2014/0213353 A1
(43) Pub. Date: Jul. 31, 2014

(54) APPARATUS AND METHOD FOR PROVIDING STREAMING-BASED GAME IMAGES

(71) Applicant: Electronics and Telecommunications Research Institute, Daejeon-city (KR)

(72) Inventors: Dong-Chun LEE, Daejeon (KR); Chang-Sik CHO, Daejeon (KR); Hun-Joo LEE, Daejeon (KR)

(73) Assignee: Electronics and Telecommunications Research Institute, Daejeon-city (KR)

(21) Appl. No.: 13/960,466

(22) Filed: Aug. 6, 2013

(30) Foreign Application Priority Data
Jan. 31, 2013 (KR) 10-2013-0011473

(51) Int. Cl. A63F 13/30

(52) U.S. Cl. CPC A63F 13/12
USPC 463/31

(57) ABSTRACT

Disclosed herein is an apparatus and method for providing streaming-based game images. The apparatus for providing streaming-based game images includes an image capturing unit for capturing an image. An image distribution unit distributes pixels constituting the image captured by the image capturing unit depending on resolutions determined by a player and a watcher, and divides an original resolution image into one or more resolution images depending on resolutions desired by the game player and the watcher. A video encoder unit activates a plurality of video encoders depending on a number of images obtained from distribution of the image distribution unit and compresses the images from the image distribution unit. A network communication unit transmits the images compressed by the video encoder unit to a terminal of the game player or a terminal of the watcher depending on the determined resolutions.

### CROSS REFERENCE TO RELATED APPLICATION

This application claims the benefit of Korean Patent Application No. 10-2013-0011473 filed on Jan. 31, 2013, which is hereby incorporated by reference in its entirety into this application.

### BACKGROUND OF THE INVENTION

1. Technical Field

The present invention relates generally to an apparatus and method for providing streaming-based game images and, more particularly, to an apparatus and method that allow two or more users to simultaneously play online games over a communication network.

2. Description of the Related Art

As our society has developed into an information-based society, personal computers have become important and essential to many aspects of life, such as society, culture, and economy. Recently, with the popularization of intelligent terminals in which computer-supporting functions, such as Internet communication and information searching, are added to mobile phones such as smart phones, the smart phones have been used to perform various functions instead of personal computers, and thus the performance of the smart phones has gradually improved. In spite of the improvement of performance of the smart phones, execution of high-quality three-dimensional (3D) game content on smart phones still has many restrictions, thus making it difficult to deviate from most 2D games that are currently played on smart phones.

Owing to the popularization of smart phones and demand for high-quality 3D game content by gamers, streaming games currently attract attention. Such a streaming game is a service for allowing a gamer to play games without installing a game program on his or her hardware device. Gamers can access a streaming server and enjoy games using game images transmitted in a streaming manner. Hardware resources enabling games to be played and game images to be displayed are present in a streaming server. The streaming server converts game images displayed based on game playing into a video format via real-time capturing and encoding operations and transfers the video format images to gamers via network communication.

FIG. 1 is a diagram showing the typical configuration of a streaming-based game system. A client server 12 executes an actual game application and plays a game performing communication with a game server 14,

User input information required to play the game (input information received through a keyboard, a mouse, or the like) is generated by each client terminal 10 and transferred to the client server 12. A changed screen image according to playing the game is captured by the client server 12 in real-time, and is transferred to the client terminal 10.

In this way, a conventional streaming based game is configured such that a person who desires to play a game accesses the client server 12 using his or her terminal (that is, the client terminal 10) and executes the game through the client server 12. A changed image according to playing the game is compressed by the client server 12 and transmitted to a user's terminal (that is, the client terminal 10) over a network (not shown). Accordingly, the user views the changed image on the monitor of his or her terminal.

Such a conventional online game method using streaming is configured such that a screen on which a game is being played is exclusively used by a single terminal, and so a game image having a resolution optimized for the terminal is captured and is transmitted to the terminal.

An invention disclosed in Korean Patent Application Publication No. 10-2012-0043481 which is one of conventional technologies relating to the present invention presents an online game server and a method of implementing the server, in which the game server captures game images using the information of a thin client accessing the game server, encodes the game images in real time, and streams the game images in real time so that an existing online game service can be provided through a thin client having low performance by means of desktop virtualization service technology, thus enabling the conventional online game service to be provided even through a low-performance client.

In order to achieve the above object, Korean Patent Application Publication No. 10-2012-0043481 presents an online game server for a desktop virtualization service system supporting an online game, including a storage unit, a conversion unit, and a control unit. The storage unit receives and stores respective hardware environments of a plurality of clients so as to execute an online game. The conversion unit encodes game images based on respective hardware environments depending on manipulation inputs respectively received from the plurality of clients. The control unit performs control such that respective online games selected by the plurality of clients are executed, game execution images are transmitted to the respective clients, and then online games are executed on the plurality of clients.

As another conventional technology relating to the present invention, there is an invention disclosed in Korean Patent Application Publication No. 10-2011-0139388. The invention disclosed in Korean Patent Application Publication 10-2011-0139388 relates to an online game method and system using streaming, which enable games to be played even on terminals that normally have difficulty executing the games while compensating for differences between the play speeds of terminals occurring due to differences in performance or network speed between client server and terminal.

In order to achieve the above object, Korean Patent Application Publication No. 10-2011-0139388 presents an online game system using streaming, which includes a game server and one or more terminals. The game server provides an online game service over a communication network, executes a game in consideration of a user's input information, and thereafter provides game video data appearing as the results of executing the game in a streaming manner. One or more terminals play the game video data streaming from the game server while receiving the game video data, and if the user's input related to the game occurs while playing the game video data, transmit the user's input information to the game server.

Such a conventional online game using streaming provides the function of allowing a user who desires to play a game to access a client server and play the game. However, such a game function is a simple one-to-one streaming function between the server and the terminal for a single captured game image without providing a user watch mode.

### SUMMARY OF THE INVENTION

Accordingly, the present invention has been made keeping in mind the above problems occurring in the prior art, and an object of the present invention is to provide an apparatus and method for providing streaming-based game images, which allow a game play image exclusively used by a single gamer (game player) to be effectively shared with a user who desires to watch a game, as well as the gamer.

In accordance with an aspect of the present invention to accomplish the above object, an apparatus for providing streaming-based game images, includes an image capturing unit for capturing an image; an image distribution unit for distributing pixels constituting the image captured by the image capturing unit depending on resolutions determined by a player and a watcher, and dividing an original resolution image into one or more resolution images depending on resolutions desired by the game player and the watcher; a video encoder unit for activating a plurality of video encoders depending on a number of images obtained from distribution of the image distribution unit and compressing the images from the image distribution unit; and a network communication unit for transmitting the images compressed by the video encoder unit to a terminal of the game player or a terminal of the watcher depending on the determined resolutions.

Preferably, the image distribution unit performs image distribution in different manners depending on the number of watchers and states of terminals.

For example, if only a game player desiring a 1 (original) resolution image and a watcher desiring a ½ resolution image require an identical game image, the image distribution unit divides the 1 (original) resolution image into two ½ resolution images (a first ½ resolution image and a second ½ resolution image), and transfers the two ½ resolution images to two activated video encoders. Images encoded by the activated video encoders are transmitted to respective user terminals via the network communication unit. The network communication unit transmits two images (the first ½ resolution image and the second ½ resolution image) to the game player who desires the original resolution, and transmits one image (the first or second ½ resolution image) to watchers who desire the ½ resolution.

As another example, if a game player desiring a 1 (original) resolution image, a watcher desiring a ½ resolution image, and a watcher desiring a ¼ resolution image require an identical game image, the image distribution unit divides the 1 (original) resolution image into two ½ resolution images (a first ½ resolution image and a second ½ resolution image), and divides the second ½ resolution image into two ¼ resolution images (a first ¼ resolution image and a second ¼ resolution image) so as to obtain ¼ resolution images. Consequently, a total of three images, that is, the first ½ resolution image, the first ¼ resolution image, and the second ¼ resolution image, are transferred to three activated video encoders. Images encoded by the activated video encoders are transmitted to respective user terminals through the network communication unit. The network communication unit transmits a total of three images (the first ½ resolution image, the first ¼ resolution image, and the second ¼ resolution image) to the game player who desires the original resolution, transmits one image (the first ½ resolution image) to the watcher who desires the ½ resolution, and transmits one image (the first or second ¼ resolution image) to the watcher who desires the ¼ resolution.

Preferably, the apparatus may further include a control unit for transmitting an input signal to a game application in response to an input signal received from the terminal of the game player and ignoring game play-related manipulation signals received from the terminal of the watcher.

In accordance with another aspect of the present invention to accomplish the above object, a method of providing streaming-based game images, includes distributing by, an image distribution unit, pixels constituting an input image depending on resolutions determined by a player and a watcher, and dividing an original resolution image into one or more resolution images depending on resolutions desired by the game player and the watcher; compressing, by a video encoder unit, the images obtained from distribution and outputting compressed images; transmitting, by a network communication unit, the compressed and output images to a terminal of the game player or a terminal of the watcher depending on the determined resolutions.

Preferably, distributing may include dividing the original resolution image into images having various resolutions.

Preferably, if the determined resolutions indicate a ½ resolution, transmitting may be configured to transmit any one of two ½ resolution images to the terminal of the game player or the watcher who desires the ½ resolution.

Preferably, if the determined resolutions indicate a ½ resolution and an original resolution, transmitting may be configured to transmit any one of two ½ resolution images to the terminal of the game player or the watcher who desires the ½ resolution and to transmit the two ½ resolution images to the terminal of the game player or the watcher who desires the original resolution.

Preferably, distributing may be configured to, if the determined resolutions further indicate a ¼ resolution other than the ½ resolution, divide any one of the two ½ resolution images into two images to form two ¼ resolution images, and transmitting may be configured to transmit the other ½ resolution images to the terminal of the game player or the watcher who desires the ½ resolution, and transmit any one of the two ¼ resolution images to the terminal of the game player or the watcher who desires the ¼ resolution.

Preferably, if the determined resolutions further indicate an original resolution other than the ½ resolution and the ¼ resolution, transmitting may be configured to transmit the one ½ resolution image and two ¼ resolution images to the terminal of the game player or the watcher who desires the original resolution, to transmit the one ½ resolution images to the terminal of the game player or the watcher who desires the ½ resolution, and transmit one of the two ¼ resolution images to the terminal of the game player or the watcher who desires the ¼ resolution.

Preferably, the method may further include transmitting, by a control unit, an input signal to a game application in response to an input signal received from the terminal of the game player and ignoring game play-related manipulation signals received from the terminal of the watcher.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the typical configuration of a streaming-based game system employed in an embodiment of the present invention;

FIG. 2 is a block diagram showing the configuration of an apparatus for providing streaming-based game images according to an embodiment of the present invention;

FIG. 3 is a block diagram showing the internal configuration of a client terminal employed in an embodiment of the present invention;

FIGS. 4(a) and 4(b) are diagrams showing the rule of distribution of a captured image according to an embodiment of the present invention;

FIG. 5 is a diagram illustrating the resolutions of images at respective levels employed in the description of the embodiment of the present invention; and

FIG. 6 is a flowchart showing a method of providing streaming-based game images according to an embodiment of the present invention.

### DESCRIPTION OF THE PREFERRED EMBODIMENTS

The present invention allows a plurality of persons, as well as a game player, to simultaneously watch a game play screen, and manages captured images in a hierarchical structure so that images optimized for respective environments can be transmitted because the same image must be transmitted to a plurality of persons provided with terminals having different performances over networks having different performances.

Hereinafter, an apparatus and method for providing streaming-based game images according to embodiments of the present invention will be described in detail with reference to the attached drawings. Prior to the detailed description of the present invention, it should be noted that the terms or words used in the present specification and the accompanying claims should not be limitedly interpreted as having their common meanings or those found in dictionaries. Therefore, the embodiments described in the present specification and constructions shown in the drawings are only the most preferable embodiments of the present invention, and are not representative of the entire technical spirit of the present invention. Accordingly, it should be understood that various equivalents and modifications capable of replacing the embodiments and constructions of the present invention might be present at the time at which the present invention was filed.

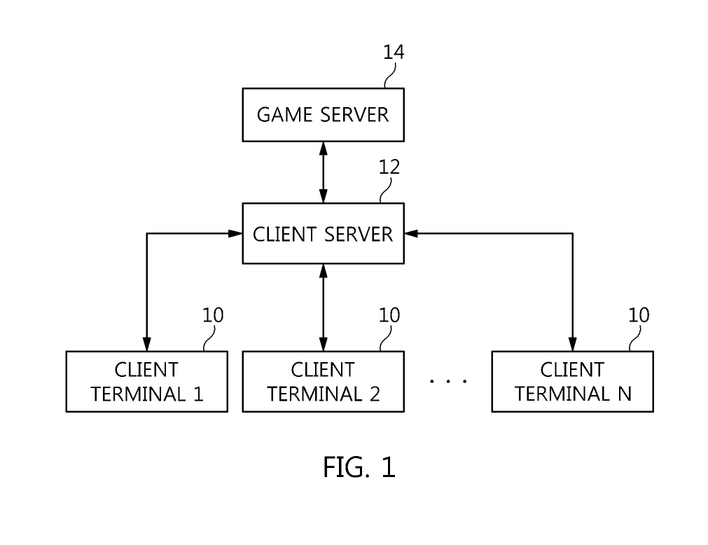

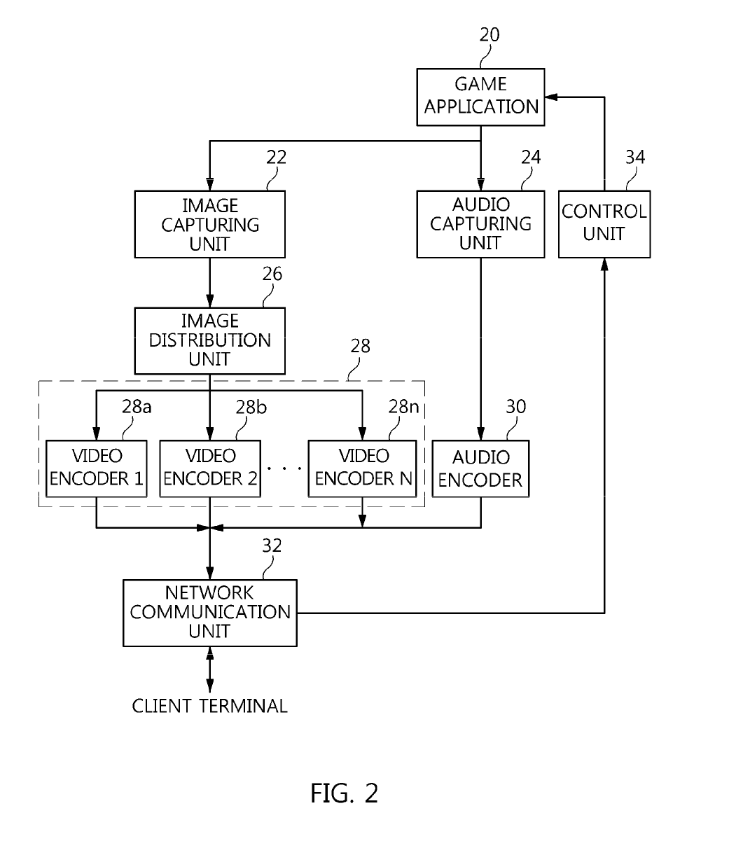

An apparatus for providing streaming-based game images according to an embodiment of the present invention may be regarded as applying the above-described stream-based game system shown in FIG. 1. FIG. 2 is a block diagram showing the configuration of an apparatus for providing streaming-based game images according to an embodiment of the present invention and may be regarded as the internal configuration of a client server.

The apparatus for providing streaming-based game images according to the embodiment of the present invention includes an image capturing unit 22, an audio capturing unit 24, an image distribution unit 26, a video encoder unit 28, an audio encoder 30, a network communication unit 30, and a control unit 34.

The image capturing unit 22 captures images generated by a game application 20 that is executed.

The audio capturing unit 24 captures audio generated by the executed game application 20.

The image distribution unit 26 distributes (divides) pixels constituting each image captured by the image capturing unit 22 depending on the resolutions determined by a game player and watchers.

The video encoder unit 28 includes a plurality of video encoders 28a to 28n. The video encoder unit 28 is configured such that a plurality of video encoders are activated depending on the number of images obtained from the distribution of the image distribution unit 26 and then compress the images from the image distribution unit 26. Here, the number of video encoders activated in the video encoder unit 28 may be regarded as being determined by game resolutions desired by a game player who is executing a single game application 20 and users who are watching the game image made by the game player.

The audio encoder 30 compresses the audio captured by the audio capturing unit 24.

The network communication unit 32 communicates with a client terminal 10. Here, the client terminal 10 may be the terminal of a game player or the terminal of a watcher. Of course, the client terminal 10 may include both the terminal of the game player and the terminal of the watcher. In particular, the network communication unit 32 enables the image captured by the image capturing unit 22 to be transmitted to the terminal of the game player and the terminal of the watcher through the image distribution unit 26 and the video encoder unit 28. The network communication unit 32 transmits a number of compressed game images identical to the number of images required by each of the game player and the watcher to the corresponding terminals of the game player and the watcher. A keyboard or mouse (touch input) signal, input through the terminal of the game player, is received by the network communication unit 32 and is then input to the control unit 34.

The control unit 34 sends an input signal to the game application 20 in response to the input signal received through the game player terminal, thus enabling the game to be smoothly played. The control unit 34 ignores game play-related manipulation signals which are received from the watcher terminal.

As described above, in FIG. 2, when the game player selects a game desired to be played, the client server executes the game application 20 and captures an image and audio generated by the game application 20 using the image capturing unit 22 and the audio capturing unit 24. The image distribution unit 26 distributes pixels constituting the captured image in conformity with a predetermined rule. The images obtained from distribution are compressed by the respective video encoders (some of the video encoders 28a to 28n) of the video encoder unit 28. Further, the compressed images, together with the audio compressed by the audio encoder 30, are transmitted to the client terminal 10 via the network communication unit 32.

Meanwhile, game input signals transmitted from the client terminal 10 (input signals for streaming service log-in, game selection, game mode [for example, watch mode or play mode] selection, resolution selection, etc.) are input to the control unit 34 via the network communication unit 32. The control unit 34 filters signals to be transferred to the game application 20 from the input signals, and then generates game input to play the game.

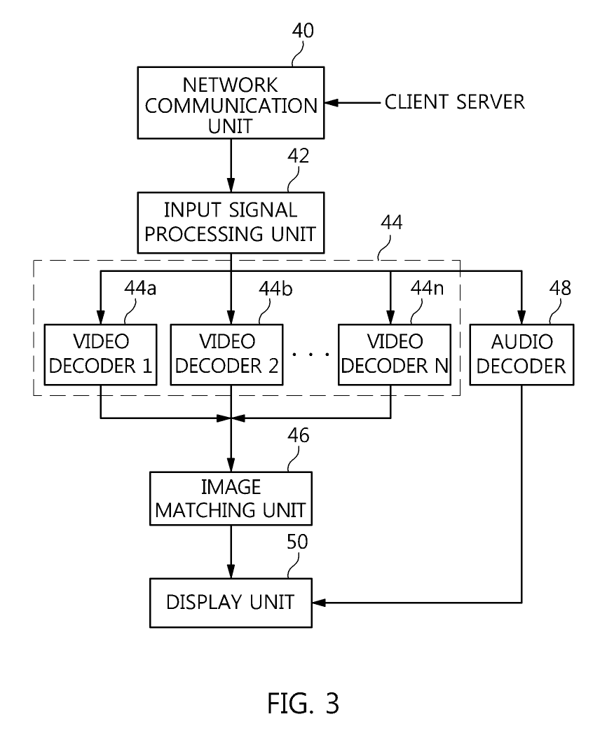

FIG. 3 is a block diagram showing the internal configuration of a client terminal according to an embodiment of the present invention.

Hierarchical image information (compressed image information) and audio information (compressed audio information) received from a client server 12 via a network communication unit 40 are transmitted to a video decoder unit 44 and an audio decoder 48 through an input signal processing unit 42. Accordingly, the respective video decoders (some of video decoders 44a to 44n) of the video decoder unit 44 decompress pieces of compressed image information.

An image matching unit 46 combines the respective pieces of decompressed image information to form one image. Then, the formed image together with audio information decompressed by and input from the audio decoder 48 are output through a display unit 50.

In FIG. 3, the number of activated video decoders 44a to 44n may be determined by the number of images received from the network communication unit 40.

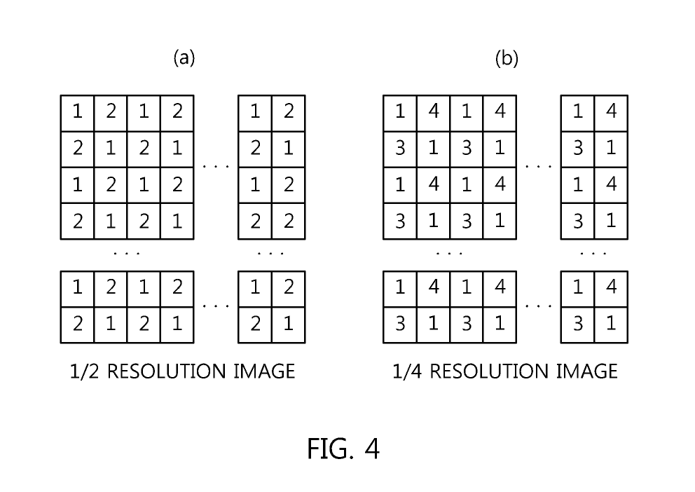

FIGS. 4(a) and 4(b) are diagrams showing the rule of distribution of a captured image according to an embodiment of the present invention, and illustrate an example of the rule of distribution of an image performed by the image distribution unit 26.

FIG. 4(a) illustrates a method of configuring two ½ resolution images, and FIG. 4(b) illustrates a method of configuring four ¼ resolution images.

If it is assumed that the size of a captured image is n(n is a natural number)*n(n is a natural number), a method of configuring a ½ resolution image is configured such that pixels in the first row of a ½ resolution image are generated using pixels in 1st, 3rd, 5th, 7th, . . . , n-1th columns, among pixels in the first row of an original image. Further, pixels in the second row of the ½ resolution image are generated using pixels in 2nd, 4th, 6th, 8th, . . . nth columns, among pixels in the second row of the original image. Furthermore, pixels in the third row of the ½ resolution image are generated using the same method as the method of generating pixels in the first row. By repeating these procedures, one ½ resolution image may be generated. The other ½ resolution image may be generated by extracting pixels at locations indicated by number 2 in the image shown in FIG. 4(a). When a user desires a ½ resolution image, only one of two ½ resolution images illustrated in FIG. 4(a) is transmitted in the embodiment of the present invention. Further, when the user desires the original resolution image, two ½ resolution images are transmitted to the user.

The configuration of a ¼ resolution image may be implemented by dividing an image composed of pixels at locations indicated by number 2, of ½ resolution images, into two images. The ¼ resolution image may be formed by dividing an image, composed of pixels at locations indicated by number 2, of the ½ resolution images of FIG. 4(a), using number 3 and number 4, as shown in FIG. 4(b). Accordingly, a ¼ resolution image is formed by extracting pixels at locations indicated by number 3 or pixels at locations indicated by number 4. If the user desires a ¼ resolution image, the client server 12 may provide a user's desired ¼ resolution image by transmitting the image composed of pixels at locations indicated by number 3 or 4. Meanwhile, when the user desires the original resolution in a game in which ¼ resolution images are used, the client server 12 transmits all of, for example, a ½ resolution image composed of pixels at locations indicated by number 1, a ¼ resolution image composed of pixels at locations indicated by number 3, and a ¼ resolution image composed of pixels at locations indicated by number 4 to the client terminal 10. The image matching unit 46 of the client terminal 10 provides the user's desired resolution image by combining those images.

Meanwhile, when the client server 12 and the client terminal 10 exchange a ½ resolution image with each other, the display unit 50 of the client terminal 10 calculates pixels of empty n/2*n image by interpolating pixels of a received n/2*n image and displays an n*n image in which pixels have been interpolated. For example, referring to the example illustrated in FIG. 4, if a ½ resolution image composed of pixels at locations indicated by number 2 is transmitted to the client terminal 10, the display unit 50 of the client terminal 10 creates pixels at locations indicated by number 1 by interpolating neighboring pixels at locations indicated by number 2, and displays the resulting image having the interpolated pixels.

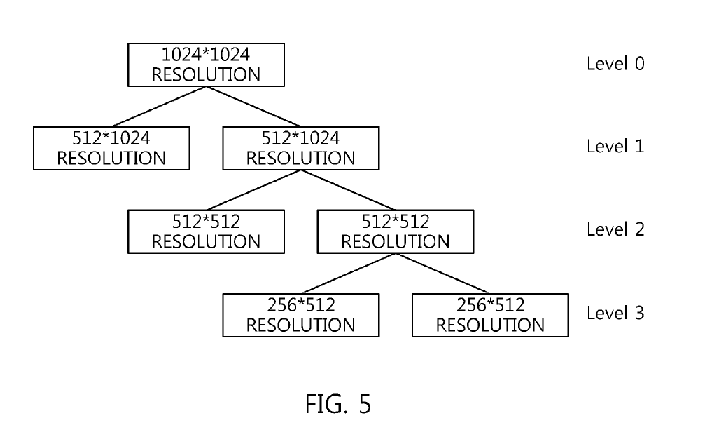

FIG. 5 is a diagram illustrating the resolutions of images at respective levels employed in the description of the embodiment of the present invention.

In FIG. 5, a highest resolution image is assumed to be a 1024*1024 image (Level 0). For example, when, among a single game player who executes a single game application 20 and a plurality of watchers who watch the game played by the player, a user's desired highest resolution is 1024*1024 and a lowest resolution is 256*512, the image distribution unit 26 forms one 512*1024 resolution image, one 512*512 resolution image, and two 256*512 resolution images, from one image captured at a resolution of 1024*1024.

Thereafter, all of the four images divided as described above are transmitted to a user who desires the highest resolution, but any one of two 256*512 resolution images is transmitted to a user who desires the lowest resolution.

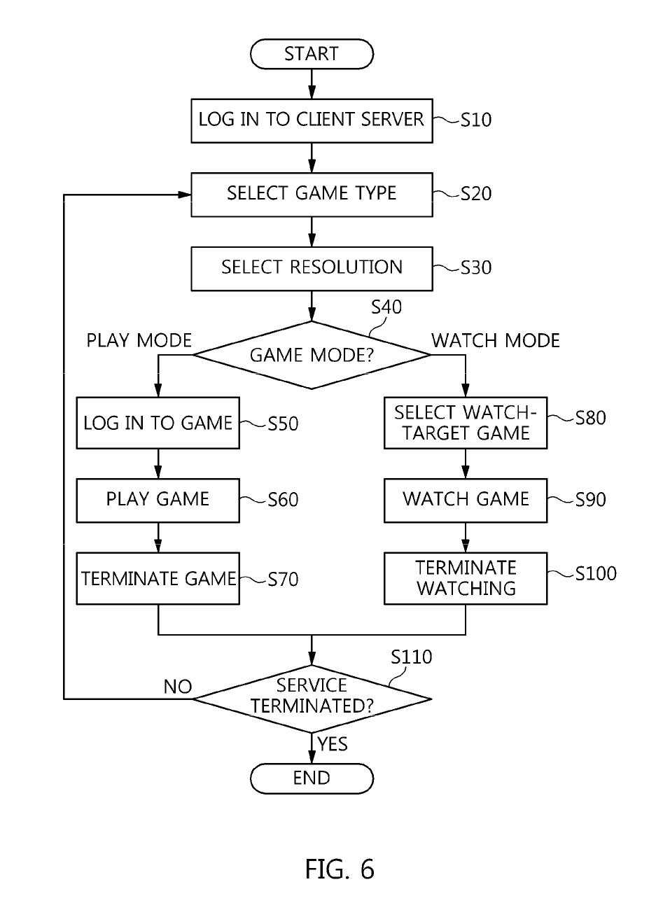

FIG. 6 is a flowchart showing a method of providing streaming-based game images according to an embodiment of the present invention.

The client terminal 10 obtains user authentication from the client server 12 so as to be provided with a streaming-based game service at client server log-in step S10.

At game type selection step S20, the user who has completed his or her log-in step selects a game desired to be played (for example, Lineage game, Aion game, Wow game, Loi game, or the like).

Thereafter, at resolution selection step S30, the user selects the resolution of an image to be received from the client server 12 in consideration of his or her network environment or the resolution of the terminal. Next, at game mode step S40, the user determines whether to actually play the game or to watch the game played by another person. If the selection of the resolution and the setting of a game mode have been completed in this way, a signal corresponding thereto is transmitted to the client server 12. Accordingly, the image distribution unit 26 of the client server 12 distributes pixels constituting an image captured by the image capturing unit 22 depending on the resolutions determined by the game player and the watchers. The video encoder unit 28 individually compresses images obtained from distribution, and transmits the compressed images to the corresponding client terminals 10 via the network communication unit 32. For example, if it is assumed that a lowest resolution selected by a plurality of client terminals 10 desiring to watch the same image is ⅛ resolution, the client server 12 divides one original image into a first ½ resolution image, a first ¼ resolution image, a first ⅛ resolution image, and a second ⅛ resolution image, and then obtains a total of four images. Meanwhile, the client server 12 transmits all of the four images to a watcher or a game player who desires the original image, but transmits one image having the corresponding resolution to a watcher or a game player who desires an image other than the original image.

The user who selects the game play mode plays the game while sequentially performing game log-in step S50, game play step S60, and game termination step 70 in a normal game play sequence. Further, the user who selects the watch mode selects a game being played by a desired game player at watch-target game selection step S80, and watches the game while performing game watching step S90 and watching termination step S100. In particular, when a watcher as well as a game player are present for a single game, the control unit 34 of the client server 12 ignores manipulation signals received from the watcher's terminal (for example, a signal required to move an object in a screen, an attack signal, a screen movement signal, etc.) without transferring them to the game application 20, and transfers only manipulation signals received from the game player to the game application 20.

Finally, the game player who terminates playing of the game and the watcher who terminates watching of the game select whether to terminate the streaming-based game service at service termination step S110.

In accordance with the present invention having the above configuration, a game is executed through a client server, and game video data obtained as a result of the execution is provided to the terminal of a user in a streaming manner, thus obtaining effects similar to those of a case where the user plays the game on the terminal in real time.

In particular, there is an advantage in that a plurality of watchers can watch a game screen on which a user is playing the game, and so the watchers can learn how to play the game while viewing the game played by the user without requiring a separate game manual, thus decreasing an obstacle of having to initially learn how to play the game.

Meanwhile, the present invention is not limited to the above embodiments, and various changes and modifications are possible, without departing from the scope and spirit of the invention. It should be understood that the technical spirit of those changes and modifications belong to the scope of the claims.

What is claimed is:

1. An apparatus for providing streaming-based game images, comprising:
an image capturing unit for capturing an image;
an image distribution unit for distributing pixels constituting the image captured by the image capturing unit depending on resolutions determined by a player and a watcher, and dividing an original resolution image into one or more resolution images depending on resolutions desired by the game player and the watcher;
a video encoder unit for activating a plurality of video encoders depending on a number of images obtained from distribution of the image distribution unit and compressing the images from the image distribution unit; and
a network communication unit for transmitting the images compressed by the video encoder unit to a terminal of the game player or a terminal of the watcher depending on the determined resolutions.

2. The apparatus of claim 1, wherein the image distribution unit is configured to perform a procedure in which pixels in a first row of a ½ resolution image are generated using pixels in odd-numbered or even-numbered columns, among pixels in a first row of a first original image from the image capturing unit, and in which pixels in a second row of the ½ resolution image are generated using pixels in even-numbered or odd-numbered columns, among pixels in a second row of the first original image, thus forming one ½ resolution image by repeating the above procedure.

3. The apparatus of claim 2, wherein if the determined resolutions indicate a ½ resolution,
the image distribution unit forms a remaining ½ resolution image based on the procedure for forming the one ½ resolution image, and
the network communication unit transmits any one of the two ½ resolution images to the terminal of the game player or the watcher who desires the ½ resolution.

4. The apparatus of claim 2, wherein if the determined resolutions indicate an original resolution,
the image distribution unit forms a remaining ½ resolution image based on the procedure for forming the one ½ resolution image, and
the network communication unit transmits the two ½ resolution images to the terminal of the game player or the watcher who desires the original resolution.

5. The apparatus of claim 2, wherein if the determined resolutions indicate a ¼ resolution,
the image distribution unit forms two ¼ resolution images by dividing the one ½ resolution image into two images, and
the network communication unit transmits any one of the two ¼ resolution images to the terminal of the game player or the watcher who desires the ¼ resolution.

6. The apparatus of claim 2, wherein if the determined resolutions indicate a ¼ resolution and an original resolution,
the image distribution unit forms a remaining ½ resolution image based on the procedure for forming the one ½ resolution image, and forms two ¼ resolution images by dividing any one of the two ½ resolution images into two images, and
the network communication unit transmits any one of the two ¼ resolution images to the terminal of the game player or the watcher who desires the ¼ resolution, and transmits the one ½ resolution image and the two ¼ resolution images to the terminal of the game player or the watcher who desires the original resolution.

7. The apparatus of claim 1, further comprising a control unit for transmitting an input signal to a game application in response to an input signal received from the terminal of the game player and ignoring game play-related manipulation signals received from the terminal of the watcher.

8. A method of providing streaming-based game images, comprising:
distributing by, an image distribution unit, pixels constituting an input image depending on resolutions determined by a player and a watcher, and dividing an original resolution image into one or more resolution images depending on resolutions desired by the game player and the watcher;
compressing, by a video encoder unit, the images obtained from distribution and outputting compressed images; and
transmitting, by a network communication unit, the compressed and output images to a terminal of the game player or a terminal of the watcher depending on the determined resolutions.

9. The method of claim 8, wherein distributing comprises:
generating pixels in a first row of a ½ resolution image using pixels in odd-numbered or even-numbered columns, among pixels in a first row of a first input image;
generating pixels in a second row of the ½ resolution image using pixels in even-numbered or odd-numbered columns, among pixels in a second row of the first input image,
repeating generating the pixels in the first row and generating the pixels in the second row, thus forming one ½ resolution image; and
forming a remaining ½ resolution image based on generating the one ½ resolution image.

10. The method of claim 9, wherein if the determined resolutions indicate a ½ resolution, transmitting is configured to transmit any one of the two ½ resolution images to the terminal of the game player or the watcher who desires the ½ resolution.

11. The method of claim 9, wherein if the determined resolutions indicate a ½ resolution and an original resolution, transmitting is configured to transmit any one of the two ½ resolution images to the terminal of the game player or the watcher who desires the ½ resolution and to transmit the two ½ resolution images to the terminal of the game player or the watcher who desires the original resolution.

12. The method of claim 9, wherein distributing is configured to, if the determined resolutions further indicate a ¼ resolution other than the ½ resolution, divide any one of the two ½ resolution images into two images, thus forming two ¼ resolution images.

13. The method of claim 12, wherein transmitting is configured to transmit the other ½ resolution images to the terminal of the game player or the watcher who desires the ½ resolution, and transmit any one of the two ¼ resolution images to the terminal of the game player or the watcher who desires the ¼ resolution.

14. The method of claim 12, wherein if the determined resolutions further indicate an original resolution other than the ½ resolution and the ¼ resolution, transmitting is configured to transmit the one ½ resolution image and two ¼ resolution images to the terminal of the game player or the watcher who desires the original resolution, to transmit the one ½ resolution images to the terminal of the game player or the watcher who desires the ½ resolution, and transmit one of the two ¼ resolution images to the terminal of the game player or the watcher who desires the ¼ resolution.

15. The method of claim 8, further comprising:
transmitting, by a control unit, an input signal to a game application in response to an input signal received from the terminal of the game player and ignoring game play-related manipulation signals received from the terminal of the watcher.
